(19) United States
(12) Patent Application Publication
(10) Pub. No.: US 2018/0347758 A1
(43) Pub. Date: Dec. 6, 2018

(54) VALVE, STORAGE FACILITY AND FILLING STATION

(71) Applicant: L'Air Liquide, Societe Anonyme pour l'Etude et l'Exploitation des Procedes Georges Claude, Paris (FR)

(72) Inventors: Yves Lacombe, Veurey-Voroize (FR); Thierry Ott, Brunoy (FR); Adrien Zanoto, Paris (FR)

(73) Assignee: L'Air Liquide, Societe Anonyme pour l'Etude et l'Exploitation des Procedes Georges Claude, Paris (FR)

(21) Appl. No.: 15/995,766

(22) Filed: Jun. 1, 2018

(30) Foreign Application Priority Data
Jun. 1, 2017 (FR) FR 1754871

(51) Int. Cl. F17C 13/00; F17C 13/04

(52) U.S. Cl. CPC F17C 13/002; F17C 2205/0332; F17C 13/04

(57) ABSTRACT

Valve comprising a body housing a fluid circuit comprising a first end intended to be connected to the orifice of at least one storage facility, at least one second, draw-off end intended to be connected to a receiver circuit, at least one third, filling end intended to be connected to a source of gas under pressure, the second end and the third end being connected to the first end via a draw-off branch of the circuit and a filler branch of the circuit, respectively, the draw-off branch and the filler branch being connected in parallel to the first end of the circuit and each comprising a set of valves, characterized in that the draw-off branch and filler branch each comprise a respective valve in series with a respective unidirectional valve.

### CROSS-REFERENCE TO RELATED APPLICATIONS

This application claims the benefit of priority under 35 U.S.C. § 119 (a) and (b) to French patent application No. FR1754871, filed Jun. 1, 2017, the entire contents of which are incorporated herein by reference.

### BACKGROUND

### Field of the Invention

The invention concerns a valve, a pressurized gas storage facility and a corresponding filling station.

The invention more particularly concerns a valve for a storage facility for fluid under pressure, in particular hydrogen gas, comprising a body housing a fluid circuit comprising a first end intended to be connected to the orifice of at least one pressurized fluid storage facility, at least one second, draw-off end intended to be connected to a receiver circuit to enable the supply of fluid drawn off from the storage facility via the circuit, at least one third, filling end intended to be connected to a source of gas under pressure to enable the filling of the storage facility via the circuit, the second end and the third end being connected to the first end via a draw-off branch of the circuit and a filler branch of the circuit, respectively, the draw-off branch and the filler branch being connected in parallel to the first end of the circuit and each comprising a set of valves.

The invention concerns in particular a high-pressure valve, notably for hydrogen applications (tank(s) and mobile or fixed stations).

### Related Art

Numerous valves and corresponding stations have been proposed for these applications. However, these known solutions do not enable optimization of filling and dispensing performance combined with modular usage.

In particular, the known solutions do not enable simultaneous guarantees of a high level of modularity of the storage facilities used in filling stations (used in particular for pressure balancing and/or as a compressor source) and good sealing of the circuit, in particular in the case of bidirectional use (filling and draw-off gas flows).

### SUMMARY OF THE INVENTION

An object of the present invention is to overcome all or some of the disadvantages of the above prior art.

To this end, the valve according to the invention, otherwise conforming to the generic definition thereof given in the above preamble, is essentially characterized in that the draw-off branch and filler branch each comprise a respective valve in series with a respective unidirectional valve.

Moreover, embodiments of the invention can include one or more of the following features:
the draw-off branch and the filler branch each comprise a valve in series with a check valve,
the valve of each of the draw-off and filler branches is a controlled valve, in particular of the pneumatic type,
the circuit includes a first isolation valve situated between on the one hand the two draw-off and filler branches and on the other hand the first end of the circuit,
the valve includes at least one safety draining member configured to free a gas evacuation passage between the first end of the circuit and at least one evacuation orifice leading to the body if the draining member is subjected to a temperature and/or a pressure above a particular threshold,
the circuit comprises a purge line having an upstream end connected in the portion situated between the first isolation valve and the two draw-off and filler branches and a downstream end connected to the evacuation orifice or orifices of the draining member, the purge line comprising a second isolation valve,
the circuit includes a pressure sensor and/or a temperature sensor,
the valve comprises two distinct draw-off ends leading to the body of the valve and fluidically connected to the draw-off branch,
the valve comprises two distinct filler ends leading to the body of the valve and fluidically connected to the filler branch,
the circuit of the valve includes a pressure sensor situated between the first isolation valve and the first end of the circuit and/or between the first isolation valve and the second isolation valve,
the circuit of the valve includes at least one pressure sensor situated between the first isolation valve and the first end of the circuit,
the at least one storage facility contains gas at a pressure between 50 and 1100 bar.

The invention also concerns a pressurized gas storage facility or pressurized gas storage facilities comprising an orifice connected to a valve according to any one of the above or following features.

The invention also concerns a station for filling pressurized gas tanks comprising at least one such pressurized gas storage facility connected to at least one transfer line intended to be connected to a pressurized gas tank to be filled to provide a transfer of gas from the storage facility to the tank, the transfer line being connected to the at least one second draw-off end of the body of the valve of the storage facility.

According to other possible features:
the at least one third filler end of the body of the valve of the storage facility is connected to a source of gas under pressure comprising a compressor and/or a gas and/or liquid tank,
the station comprises a plurality of pressurized gas storage facilities connected to the transfer line, said storage facilities conforming to the features above or below, at least some of the storage facilities being connected in parallel to the transfer line via the at least one second draw-off end of the circuit of each of the storage facilities,
at least some of the storage facilities are connected in parallel to the pressurized gas source via the at least one third filler end of the circuit of each storage facility,
the storage facility conforms to any one of the above or following features, the storage facilities being connected in parallel to a gas evacuation line via the at least one evacuation orifice of the circuit of each of the storage facilities.

The invention can also concern any alternative device or method comprising any combination of the above or following features within the context of the claims.

### BRIEF DESCRIPTION OF THE FIGURES

Other features and advantages will become apparent on reading the following description given with reference to the figures in which:

FIG. 1 is a diagrammatic partial view illustrating an example of a storage facility comprising a valve according to a first embodiment of the invention,

FIG. 2 is a diagrammatic partial view showing an example of a filling station comprising a set of storage facilities according to the invention,

FIG. 3 is a diagrammatic partial view showing another example of a filling station comprising a set of storage facilities according to the invention.

### DETAILED DESCRIPTION OF THE INVENTION

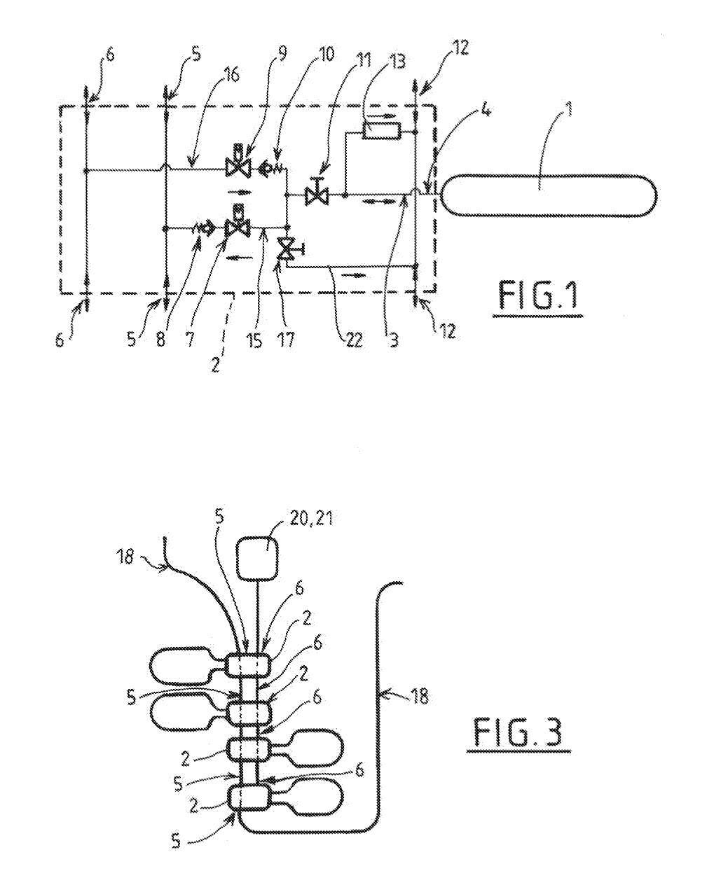

The valve shown in FIG. 1 is connected to the (preferably single) orifice of a pressurized fluid storage facility, notably a pressurized hydrogen gas storage facility, for example at a pressure up to 1100 bar (metal or composite storage facility structure for example).

The valve comprises a body 2 housing a fluid circuit 3 comprising a first end 4 connected to the orifice of the storage facility 1. For example, the first end 4 of the valve leads to the level of an externally threaded portion intended to be threaded into the internally threaded orifice of the storage facility 1. Alternatively, this first end could of course be connected to a set of distinct storage facilities (a rack of cylinders for example). In other words, the valve would be common to a plurality of storage facilities and connected to the latter by circuitry.

The fluid circuit 3 of the valve comprises at least one second draw-off end 5 intended to be connected to a receiver circuit to enable the supply of fluid drawn off from the storage facility 1. As described in more detail below, in the non-limiting example shown in FIG. 1, the circuit 3 may include two distinct second draw-off ends 5 which lead to the body 2 of the valve.

The at least one second draw-off end 5 leads to the body 2 for example at the level of a standard or non-standard fluidic connector.

The circuit 3 also comprises at least one third filler end 6 intended to be connected to a source of gas under pressure to enable filling of the storage facility 1. As before, two filler ends 6 can lead to the body 2 (for example at the level of respective standard or non-standard fluidic connectors).

The second end 5 and the third end 6 are therefore distinct and connected to the first end 4 via respective branches of the circuit 3: respectively a draw-off branch 15 and a filler branch 16. In other words, for filling and for drawing off from the storage facility 1, the fluid passes through distinct orifices of the valve (independent inlet and outlet) before taking a common circuit portion (the two branches 15, 16 joining before or at the level of the first end 4 of the circuit 3).

In other words, the draw-off branch 15 and the filler branch 16 are connected in parallel at the first end 4. The draw-off branch 15 and the filler branch 16 each comprise a set of valves. To be more precise, the draw-off branch 15 and the filler branch 16 each comprise a respective valve 7, 9 in series with a respective unidirectional valve 8, 10. These unidirectional valves (8, 10) are of opposite directions (allowing the flow of gas only towards the storage facility 1 in the filler branch 16 and allowing the flow of gas only towards the at least one second end in the draw-off branch 15).

Each valve 7, 9 is for example a motorized valve, in particular a pneumatic valve. Of course any other type of valve can be envisaged (manual valve, solenoid valve, hydraulic valve, . . . ).

Each respective unidirectional valve 8, 10 is for example a check valve (mobile closure member associated with a return member that can be opened by a pressure differential in only one direction (the filler direction or the draw-off direction, respectively)).

As described in detail hereinafter, this architecture with double inlets 6 and double outlets 5 enables integration of a storage facility 1 of this kind into a circuit of a filling station with a guaranteed good seal in the case of bidirectional use (filling of/drawing off from the storage facility 1). In particular, this architecture makes it possible to ensure sealing of the valves 7, 9 which operate in a unidirectional and non-bidirectional manner.

This also enables decorrelation of pressurization and depressurization of the storage facility 1. This also enables simplification of the assembly and the maintenance of a storage facility 1 of this kind in a circuit into which it is integrated.

This architecture enables the valve to have a high working pressure, for example 1100 bar.

The circuit 3 of the valve preferably also includes a first isolation valve 11 situated between on the one hand the two draw-off and filler branches 15, 16 and on the other hand the first end 4 of the circuit 3. In other words the first isolation valve 11 is situated on the portion of the circuit 3 that is common to the operations of filling/drawing off from the storage facility 1. This first isolation valve 1 can be a manual valve and/or a motorized valve.

The valve preferably also includes a safety draining member 13 configured to free a passage for evacuation of the gas from the storage facility 1 if it is subjected to a temperature and/or a pressure above a particular threshold. This optional member 13 is for example a fusible member that opens up a (normally closed) passage between the first end 4 of the circuit 3 and at least one evacuation orifice 12 leading to the body 2 (for example two evacuation orifices 12 as shown here).

The circuit 3 can also comprise a purge line 22 having an upstream end connected to the first isolation valve 11 and the two draw-off and filler branches 15, 16 and a downstream end connected to the evacuation orifice or orifices 12 of the draining member 13. This purge line 22 comprises for example a second (manual and/or motorized) isolation valve 17. Opening the second isolation valve 17 therefore enables evacuation via the evacuation orifice or orifices 12 of the pressurized gas situated between the first isolation valve 11 and the two filler/drawing off branches 15, 16. The evacuation orifice or orifices 12 can be vented to the atmosphere and/or connected to a gas recovery volume. This purge line can be used to drain the storage facility.

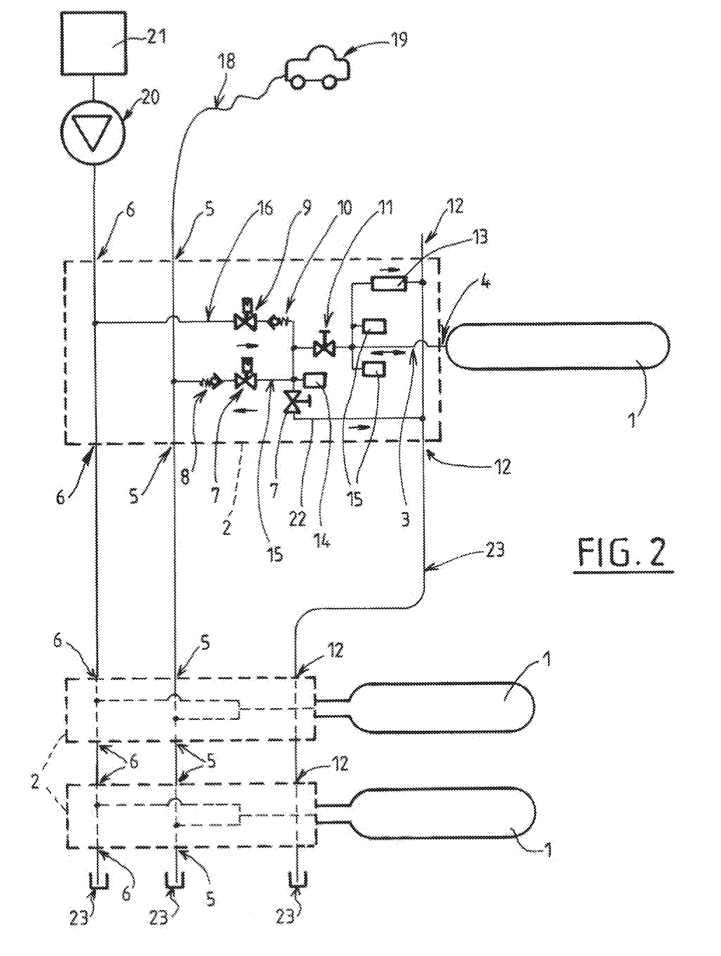

As shown in FIG. 2, the circuit 3 can also include a pressure sensor 14 and/or a temperature sensor 15. For example, the circuit 3 of the valve can include a pressure sensor 14 situated between the first isolation valve 11 and the first end 4 of the circuit 3, for example between the first isolation valve 11 and the second isolation valve 17.

Likewise, the circuit 3 of the valve can include at least one pressure sensor 15 situated between the first isolation valve 11 and the first end 4 of the circuit 3.

According to one advantageous possible feature, the circuit 3 preferably includes two distinct filler ends 6 leading to the body 2 of the valve and fluidically connected to the filler branch 16. In other words, the two distinct filler ends 6 can communicate fluidically with one another and with the filler branch 16.

Likewise, the circuit 3 can include two distinct draw-off ends 5 leading to the body 2 of the valve and fluidically connected to the draw-off branch 15. In other words the two distinct draw-off ends 5 can communicate fluidically with one another and with the draw-off branch 15.

This valve architecture advantageously enables use of a storage facility of this kind in a gas installation, in particular in a station for filling tanks, in particular hydrogen tanks. In particular (cf. FIG. 2), a third filler end 6 of the body 2 of the valve of the storage facility 1 can be connected to a source 20, 21 of gas under pressure (comprising for example a compressor 20 and/or a tank 21 of gas and/or liquid, . . . ) to enable filling of the storage facility 1 with the gas supplied by the source 20, 21.

As shown in FIG. 2, a station for filling tanks 19 can in particular use a plurality of storage facilities 1 according to FIG. 1 as buffer stores used to transfer gas into a tank 19 by balancing pressure (in particular in cascade) and/or as a gas source for a filler compressor.

The station shown in FIG. 2 comprises a plurality of storage facilities 1 (three in this example, but there could be two or more than three). The storage facilities 1 are connected in parallel to the transfer line 18 via the at least one second, draw-off end 5 of the valve of each of the storage facilities 1.

To be more precise, a first storage facility 1 (at the top in FIG. 2) includes a second, draw-off end 5 that is directly connected to the tank(s) 19 to be filled (via the line 18). The other filler end 5 of this first storage facility 1 is connected to a draw-off end 5 of the adjacent second storage facility 1. The other filler end 5 of this second storage facility 1 is connected to a draw-off end 5 of the adjacent third storage facility 1.

Of course, the draw-off ends (connectors) 5 of all the storage facilities 1 are not necessarily all connected/linked to one another and to the same draw-off line 18. This enables provision of a multiple gas dispenser with the same gas source. For example, the installation can include two (or more) groups of storage facilities respectively connected to two (or more) distinct transfer lines 18. All these storage facilities 1 can on the other hand be connected to the same source (or distinct sources) via their draw-off ends 6. In the case for example of four storage facilities 1 connected to two transfer lines 18, the draw-off ends 5 of two storage facilities 1 can be connected in parallel to a first transfer line 18 whereas the draw-off ends 5 of the other two storage facilities 1 are connected in parallel to the other transfer line 18. The four storage facilities can be connected to the same source 20, 21 via the filler ends 6. Cf. FIG. 3.

Likewise, the first storage facility 1 (at the top in FIG. 2) includes a filler end 6 connected (directly, i.e. as close as possible) to the source 20, 21 of gas under pressure whereas the other filler end 6 of this first storage facility 1 is connected to a filler end 6 of the valve of the adjacent second storage facility 1. The other filler end 6 of this second storage facility 1 is connected to a filler end 6 of the valve of the third storage facility 1.

Finally, the evacuation orifices 12 of the three storage facilities can be connected to the same purge line 23.

The ends/orifices 5, 6, 12 of the valves of the storage facilities are therefore respectively connected in parallel:
to the transfer line 18,
to the gas source 20, 21, and
to the purge line 23.

As before, not all the draw-off ends of all the tanks are necessarily linked/connected to one another but can be grouped/linked to distinct transfer lines 18.

The ends/orifices of the valve of the final storage facility 1 (the one farthest away, at the row end, at the bottom in FIG. 2) can be blocked by a system of plugs 23 for example.

Each valve associated with its storage facility 1 therefore has a double system of orifices/outlets 5, 6, 12 enabling a double connection that simplifies the interconnections between the storage facilities and the rest of the station.

In this way it is relatively easy to add a storage facility 1 in parallel or to remove a storage facility at one end of this row of storage facilities 1. The costs linked to the connection of such storage facilities 1 can be minimized.

This architecture enables filling of a storage facility 1 while another is dispensing gas to a tank 22. This enables the provision of a plurality of independent dispensing terminals drawing from the same source (the compressor 20).

This architecture in particular enables parallel use of the storage facilities 1 in accordance with the cascade principle (without being limited as to the number of storage facilities 1) to optimize the quantity of gas stored in these storage facilities (for example approximately 30% by volume of residual hydrogen).

This architecture limits the number of connectors whilst enabling a high level of modularity.

Moreover, this architecture enables use of one or more storage facilities 1 to fill one or more other storage facilities 1 of the installation (for example by balancing and where necessary from the source 20, 21).

This in particular enables a gradual increase in the daily capacity of the station. This also enables the number of cascade steps to be increased if necessary.

Each storage facility 1 with its associated valve enables the replacement when necessary of a plurality of prior art storage facilities at the same time as simplifying installation and maintenance. This enables optimization of cascade filling using 60 to 70% of its capacity (instead of 30% in prior art solutions). One or more storage facilities 1 can also be used to fill one or more other storage facilities 1 (if necessary via a compressor).

If the valve of a storage facility 1 comprises a sensor or sensors for sending the pressure (and where applicable the temperature) of the gas in the circuit 3, the quantity of gas drawn off from each storage facility 1 (or with which it is filled) can be calculated using a gas state equation (PV=z.n.R.T for example).

This can replace or supplement a measurement by a mass flow meter.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A valve for a storage facility for fluid under pressure, the fluid being hydrogen gas, said valve comprising a body housing a fluid circuit, the circuit comprising:
a first end adapted and configured to be connected to the orifice of at least one pressurized fluid storage facility;
at least one second end each of which being a draw-off end, each of said at least one second end adapted and configured to be connected to a receiver circuit to enable a supply of fluid drawn off from the at least one pressurized storage facility via the circuit;
at least one third, being a filling end, adapted and configured to be connected to a source of gas under pressure so that the filling of the storage facility may be filled via the circuit;
a draw-off branch, the second end being connected to the first end via the draw-off branch, the draw-off branch comprising, in series, a draw-off branch valve and a unidirectional valve that has a flow direction in a draw-off flow direction; and
a filler branch, the third end being connected to the first end via the filler branch of the circuit, the draw-off branch and the filler branch being connected in parallel to the first end of the circuit, the filler branch comprising, in series, a filler branch valve and a unidirectional valve that has a flow direction in a filling direction opposite that of the draw-flow direction.

2. The valve of claim 1, wherein each of the unidirectional valves is a check valve.

3. The valve of claim 2, wherein each of the draw-off branch valve and filler branch valve is a pneumatically controlled valve.

4. The valve of claim 1, wherein the circuit further comprises a first isolation valve situated between, on the one hand, the two draw-off and filler branches, and on the other hand, the first end of the circuit.

5. The valve of claim 1, further comprising at least one safety draining member configured to free a gas evacuation passage between the first end of the circuit and at least one evacuation orifice leading to the body if the draining member is subjected to a temperature and/or a pressure above a particular threshold.

6. The valve of claim 4, further comprising at least one safety draining member configured to free a gas evacuation passage between the first end of the circuit and at least one evacuation orifice leading to the body if the draining member is subjected to a temperature and/or a pressure above a particular threshold, wherein the circuit comprises a purge line having an upstream end connected in the portion situated between the first isolation valve and the two draw-off and filler branches and a downstream end connected to the evacuation orifice or orifices of the draining member, the purge line comprising a second isolation valve.

7. The valve of claim 1, wherein the circuit includes a pressure sensor and/or a temperature sensor.

8. The valve of claim 1, further comprising two distinct draw-off ends leading to the body of the valve and fluidically connected to the draw-off branch.

9. The valve of claim 1, further comprising two distinct filler ends leading to the body of the valve and fluidically connected to the filler branch.

10. A pressurized gas storage facility comprising an orifice that is connected to the valve of claim 1.

11. A station for filling pressurized gas tanks comprising:
at least one of the pressurized gas storage facility of claim 10 connected to at least one transfer line adapted and configured to be connected to a pressurized gas tank to provide a transfer of gas from the storage facility to the tank so that the tank may be filled with the gas, wherein the transfer line is connected to the at least one second draw-off end of the body of the valve of the storage facility.

12. The filling station of claim 11, wherein the body of the valve of the storage facility comprises at least one third end, each being a filler end, connected to a source of gas under pressure, the source of gas under pressure comprising a compressor and/or a gas and/or liquid tank.

13. The filling station of claim 11, wherein at least some of the at least one storage facility are connected in parallel to the at least one transfer line via the at least one second draw-off end of the respective circuit of the respective storage facility.

14. The filling station of claim 12, wherein:
at least some of the at least one storage facility are connected in parallel to the at least one transfer line via the at least one second draw-off end of the respective circuit of the respective storage facility; and
at least some of the at least one storage facility are connected in parallel to the pressurized gas source via the at least one third filler end of the respective circuit of the respective storage facility.

15. (canceled)

16. The filling station of claim 11, further comprising at least one safety draining member adapted and configured to free a gas evacuation passage between the first end of the circuit and at least one evacuation orifice leading to the body of the valve if the draining member is subjected to a temperature and/or a pressure above a particular threshold.
